(19) United States
(12) Patent Application Publication
(10) Pub. No.: US 2024/0232312 A1
(43) Pub. Date: Jul. 11, 2024

(54) AUTHENTICATION DEVICE AND AUTHENTICATION METHOD

(71) Applicant: PANASONIC INTELLECTUAL PROPERTY MANAGEMENT CO., LTD., Osaka (JP)

(72) Inventors: Teppei FUKUDA, Fukuoka (JP); Masanari MIYAMOTO, Fukuoka (JP); Naoya TANAKA, Osaka (JP)

(73) Assignee: PANASONIC INTELLECTUAL PROPERTY MANAGEMENT CO., LTD., Osaka (JP)

(21) Appl. No.: 18/614,133

(22) Filed: Mar. 22, 2024

Related U.S. Application Data
(63) Continuation of application No. PCT/JP2022/032468, filed on Aug. 29, 2022.

(30) Foreign Application Priority Data
Sep. 27, 2021 (JP) 2021-157045

(51) Int. Cl. G06F 21/32; G06F 21/44; G10L 17/14; G10L 21/0208

(52) U.S. Cl. CPC G06F 21/32; G06F 21/44; G10L 17/14; G10L 21/0208; G06F 2221/2137

(57) ABSTRACT

An authentication device includes an acquisition unit configured to acquire a voice signal of a speaker; a detection unit configured to detect a first utterance period during which the speaker is speaking; and an authentication unit configured to authenticate the speaker based on a comparison between a voice signal of the first utterance period and a database. The detection unit detects a second utterance period different from the first utterance period when the authentication unit determines that the speaker authentication is impossible, and the authentication unit authenticates the speaker based on a comparison between the voice signal of the first utterance period and a voice signal of the second utterance period, and the database.

### CROSS-REFERENCE TO RELATED APPLICATIONS

This is a continuation of International Application No. PCT/JP2022/032468 filed on Aug. 29, 2022, and claims priority from Japanese Patent Application No. 2021-157045 filed on Sep. 27, 2021, the entire contents of which are incorporated herein by reference.

### TECHNICAL FIELD

The present disclosure relates to an authentication device and an authentication method.

### BACKGROUND ART

Patent Literature 1 discloses an authentication device for confirming the identity of a speaker who makes a call by using a telephone terminal connected to a telephone network, and for determining the identity of the speaker based on a voice recognition and authentication result. The authentication device stores predetermined voiceprint information, a first keyword, and a second keyword, acquires voiceprint information based on a voice received by a receiving means, and performs voiceprint authentication by comparing the voiceprint information and the stored predetermined voiceprint information. The authentication device transmits to the telephone terminal a voice message prompting the speaker to speak the first keyword, and then determines whether a content of the voice of the speaker received by the receiving means corresponds to the first keyword stored in a storage means. When an authentication result using the voiceprint information is different from the voice recognition and authentication result using the first keyword, the authentication device transmits to the telephone terminal a voice message prompting the speaker to speak the second keyword, and then determines whether the content of the voice of the speaker received by the receiving means corresponds to the second keyword stored in the storage means, thereby confirming the identity of the speaker.

### CITATION LIST

### Patent Literature

PTL 1: JP2010-109618A

### SUMMARY OF INVENTION

In the voiceprint authentication, when a data length of voice data is short, an authentication accuracy may decrease and the identity may be denied. Therefore, in Patent Literature 1, the voiceprint authentication and the voice recognition and authentication are executed to confirm the identity of the speaker. Therefore, the authentication device assists to confirm the identity by comparing a voice recognition result of the voice of the speaker with the first keyword or the second keyword stored in the storage means, and is not intended to improve the authentication accuracy of the voiceprint authentication using the voiceprint information.

The present disclosure has been made in view of the above situation in the related art, and an object thereof is to provide an authentication device and an authentication method that improve the voice authentication accuracy of a speaker using an utterance voice.

The present disclosure provides an authentication device including: an acquisition unit configured to acquire a voice signal of an utterance voice of a speaker; a detection unit configured to detect a first utterance period during which the speaker is speaking based on the acquired voice signal; and an authentication unit configured to authenticate the speaker based on a comparison between a voice signal of the first utterance period detected by the detection unit and a database, in which the detection unit detects a second utterance period different from the first utterance period when the authentication unit determines that the speaker authentication is impossible, and the authentication unit authenticates the speaker based on a comparison between the voice signal of the first utterance period and a voice signal of the second utterance period, and the database.

In addition, the present disclosure provides an authentication method performed by one or more computers, the authentication method including: acquiring a voice signal of an utterance voice of a speaker; detecting a first utterance period during which the speaker is speaking based on the acquired voice signal; authenticating the speaker based on a comparison between a voice signal of the detected first utterance period and a database, detecting a second utterance period different from the first utterance period when it is determined that the speaker authentication is impossible based on the voice signal of the first utterance period, and authenticating the speaker based on a comparison between the voice signal of the first utterance period and a voice signal of the second utterance period, and the database.

According to the present disclosure, it is possible to improve the voice authentication accuracy of the speaker using the utterance voice.

### BRIEF DESCRIPTION OF DRAWINGS

FIG. 1 is a diagram illustrating an example of a use case of a voice authentication system according to Embodiment 1.

FIG. 2 is a block diagram illustrating an example of an internal configuration of an authentication analysis device according to Embodiment 1.

FIG. 3 is a diagram illustrating an example of a first user authentication processing according to Embodiment 1.

FIG. 4 is a diagram illustrating an example of a second user authentication processing according to Embodiment 1.

FIG. 5 is a diagram illustrating an example of a third user authentication processing according to Embodiment 1.

FIG. 6 is a diagram illustrating an example of a fourth user authentication processing according to Embodiment 1.

FIG. 7 is a diagram illustrating an example of a fifth user authentication processing according to Embodiment 1.

FIG. 8 is a diagram illustrating an example of a sixth user authentication processing according to Embodiment 1.

FIG. 9 is a diagram illustrating the example of the sixth user authentication processing according to Embodiment 1.

FIG. 10 is a flowchart illustrating an example of an operation procedure of the authentication analysis device according to Embodiment 1.

### DESCRIPTION OF EMBODIMENTS

Hereinafter, embodiments specifically disclosing an authentication device and an authentication method according to the present disclosure will be described in detail with reference to the drawings as appropriate. However, the unnecessarily detailed description may be omitted. For example, the detailed description of already well-known matters and the redundant description of substantially the same configuration may be omitted. This is to avoid the following description from being unnecessarily redundant and to facilitate understanding for those skilled in the art. The accompanying drawings and the following description are provided for those skilled in the art to fully understand the present disclosure, and are not intended to limit the subject matters described in the claims.

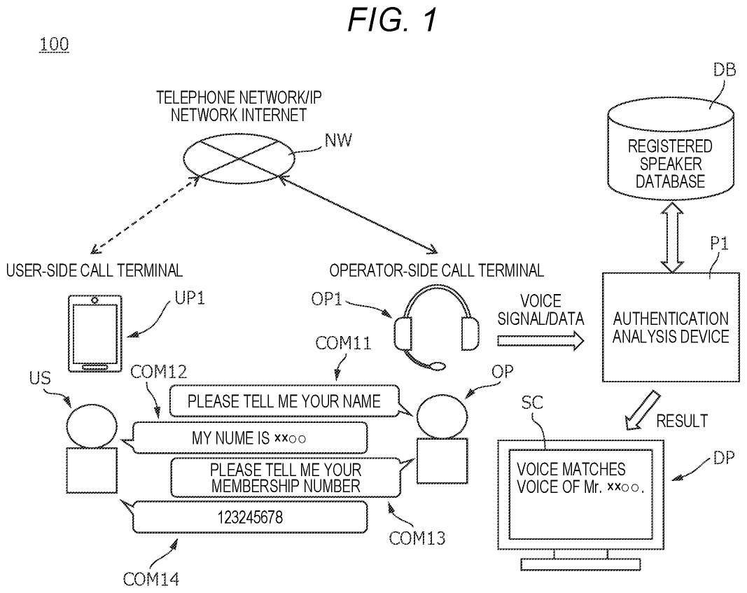

First, a use case of a voice authentication system 100 according to Embodiment 1 will be described with reference to FIG. 1. FIG. 1 is a diagram illustrating an example of the use case of the voice authentication system 100 according to Embodiment 1. The voice authentication system 100 acquires a voice signal or voice data of a person (user US in the example illustrated in FIG. 1) who is a voice authentication target, and compares the acquired voice signal or voice data with a plurality of voice signals or a plurality of pieces of voice data registered (stored) in advance in a storage (registered speaker database DB in the example illustrated in FIG. 1). The voice authentication system 100 evaluates a similarity between a user who is a voice authentication target and the voice signal or the voice data registered in the storage based on a comparison result, and authenticates the user US based on the evaluated similarity.

The voice authentication system 100 according to Embodiment 1 includes at least an operator-side call terminal OP1 as an example of a sound collection device, an authentication analysis device P1, the registered speaker database DB, and an information display unit DP as an example of an output device. The authentication analysis device P1 and the registered speaker database DB may be integrated with each other. Similarly, the authentication analysis device P1 and the information display unit DP may be integrated with each other.

The voice authentication system 100 illustrated in FIG. 1 is an example that is used for speaker (user US) authentication in a call center, and authenticates the user US using the voice data obtained by collecting an utterance voice of the user US who is communicating with an operator OP. The voice authentication system 100 illustrated in FIG. 1 further includes a user-side call terminal UP1 and a network NW. It is needless to say that the overall configuration of the voice authentication system 100 is not limited to the example illustrated in FIG. 1.

The user-side call terminal UP1 is connected to the operator-side call terminal OP1 via the network NW so as to be able to perform wireless communication. Here, the wireless communication is, for example, communication via a wireless local area network (LAN) such as Wi-Fi (registered trademark).

The user-side call terminal UP1 is implemented by, for example, a notebook PC, a tablet terminal, a smartphone, and a telephone. The user-side call terminal UP1 is a sound collection device including a microphone (not illustrated), converts the utterance voice of the user US into a voice signal by collecting the utterance voice, and transmits the voice signal converted via the network NW to the operator-side call terminal OP1. In addition, the user-side call terminal UP1 acquires a voice signal of an utterance voice of the operator OP transmitted from the operator-side call terminal OP1 and outputs the voice signal from a speaker (not illustrated).

The network NW is an IP network or a telephone network, and connects the user-side call terminal UP1 and the operator-side call terminal OP1 so as to be able to transmit and receive voice signals. The transmission and reception of data are executed by wired communication or wireless communication. Here, the wireless communication is, for example, communication via the wireless LAN such as Wi-Fi (registered trademark).

The operator-side call terminal OP1 is connected to the user-side call terminal UP1 and the authentication analysis device P1 so as to be able to transmit and receive data by wired communication or wireless communication, and transmits and receives voice signals.

The operator-side call terminal OP1 is implemented by, for example, the notebook PC, the tablet terminal, the smartphone, and the telephone. The operator-side call terminal OP1 acquires the voice signal based on the utterance voice of the user US transmitted from the user-side call terminal UP1 via the network NW, and transmits the voice signal to the authentication analysis device P1. When the operator-side call terminal OP1 acquires the voice signals including the acquired utterance voice of the user US and the acquired utterance voice of the operator OP, the operator-side call terminal OP1 may separate the voice signal based on the utterance voice of the user US and the voice signal based on the utterance voice of the operator OP based on voice parameters such as a sound pressure level and a frequency band of the voice signals of the operator-side call terminal OP1. The operator-side call terminal OP1 extracts only the voice signal based on the utterance voice of the user US after the separation and transmits the extracted voice signal to the authentication analysis device P1.

The operator-side call terminal OP1 may be connected to each of a plurality of user-side call terminals so as to be able to communicate with each other, and may simultaneously acquire voice signals from the plurality of user-side call terminals. The operator-side call terminal OP1 transmits the acquired voice signals to the authentication analysis device P1. Accordingly, the voice authentication system 100 can execute a voice authentication processing and a voice analysis processing of each of a plurality of users at the same time.

In addition, the operator-side call terminal OP1 may acquire voice signals including respective utterance voices of the plurality of users at the same time. The operator-side call terminal OP1 extracts the voice signal for each user from the voice signals of the plurality of users acquired via the network NW and transmits the voice signal for each user to the authentication analysis device P1. In such a case, the operator-side call terminal OP1 may analyze the voice signals of the plurality of users and separate and extract the voice signals for each user based on the voice parameters such as the sound pressure level and the frequency band. When the voice signal is collected from an array microphone or the like, the operator-side call terminal OP1 may separate and extract the voice signals for each user based on an arrival direction of the utterance voice. Accordingly, the voice authentication system 100 can execute the voice authentication processing and the voice analysis processing for each of the plurality of users, even if the voice signals are collected in an environment in which the plurality of users speak at the same time, such as a Web conference.

The authentication analysis device P1, which is an example of the authentication device and a computer, is connected to the operator-side call terminal OP1, the registered speaker database DB, and the information display unit DP so as to be able to transmit and receive data. The authentication analysis device P1 may be connected to the operator-side call terminal OP1, the registered speaker database DB, and the information display unit DP via a network (not illustrated) so as to be able to perform wired communication or wireless communication.

The authentication analysis device P1 acquires the voice signal of the user US transmitted from the operator-side call terminal OP1, and performs voice analysis on the acquired voice signal, for example, for each frequency, to extract an utterance feature amount of the individual user US. The authentication analysis device P1 refers to the registered speaker database DB, and executes voice authentication of the user US by comparing an utterance feature amount of each of the plurality of users registered in advance in the registered speaker database DB with the extracted utterance feature amount. The authentication analysis device P1 may execute the voice authentication of the user US by collating an utterance feature amount of a specific user registered in advance in the registered speaker database DB with the extracted utterance feature amount, instead of the utterance feature amount of each of the plurality of users registered in advance in the registered speaker database DB.

The authentication analysis device P1 generates an authentication result screen SC including a user authentication result and transmits the authentication result screen SC to the information display unit DP for output. It is needless to say that the authentication result screen SC illustrated in FIG. 1 is an example and is not limited thereto. The authentication result screen SC illustrated in FIG. 1 includes a message that “The voice matches the voice of Mr. xx∘∘.”, which is the user authentication result.

In addition, the authentication analysis device P1 may execute the voice authentication of the user US by collating the voice signal of each of the plurality of users registered in advance in the registered speaker database DB with the voice signal of the user US. The authentication analysis device P1 may execute the voice authentication of the user US by collating the voice signal of the specific user registered in advance in the registered speaker database DB with the voice signal of the user US instead of the voice signal of each of the plurality of users registered in advance in the registered speaker database DB.

The registered speaker database DB, which is an example of a database, is a so-called storage, and is implemented using a storage medium such as a flash memory, a hard disk drive (HDD), or a solid state drive (SSD). The registered speaker database DB stores (registers) user information and the utterance feature amounts of the plurality of users in association with each other. Here, the user information is information related to the user, and is, for example, a user name, a user identification (ID), and identification information assigned to each user. The registered speaker database DB may be integrated with the authentication analysis device P1.

The information display unit DP is implemented by, for example, a liquid crystal display (LCD) or an organic electroluminescence (EL) display, and displays the authentication result screen SC transmitted from the authentication analysis device P1.

In the example illustrated in FIG. 1, the user-side call terminal UP1 collects an utterance voice COM12 that “my name is ××∘∘” and an utterance voice COM14 of “123245678” of the user US, converts the collected utterance voices into voice signals, and transmits the voice signals to the operator-side call terminal OP1. The operator-side call terminal OP1 transmits the voice signals based on the utterance voices COM12 and COM14 of the user US transmitted from the user-side call terminal UP1 to the authentication analysis device P1.

When the operator-side call terminal OP1 acquires voice signals obtained by collecting an utterance voice COM11 that “please tell me your name”, and an utterance voice COM13 that “please tell me your membership number” of the operator OP, and the utterance voices COM12 and COM14 of the user US, the operator-side call terminal OP1 separates and removes the voice signals based on the utterance voices COM11 and COM13 of the operator OP, extracts only the voice signals based on the utterance voices COM12 and COM14 of the user US, and transmits the voice signals to the authentication analysis device P1. Accordingly, the authentication analysis device P1 can improve a user authentication accuracy by using only the voice signal of the person who is a voice authentication target.

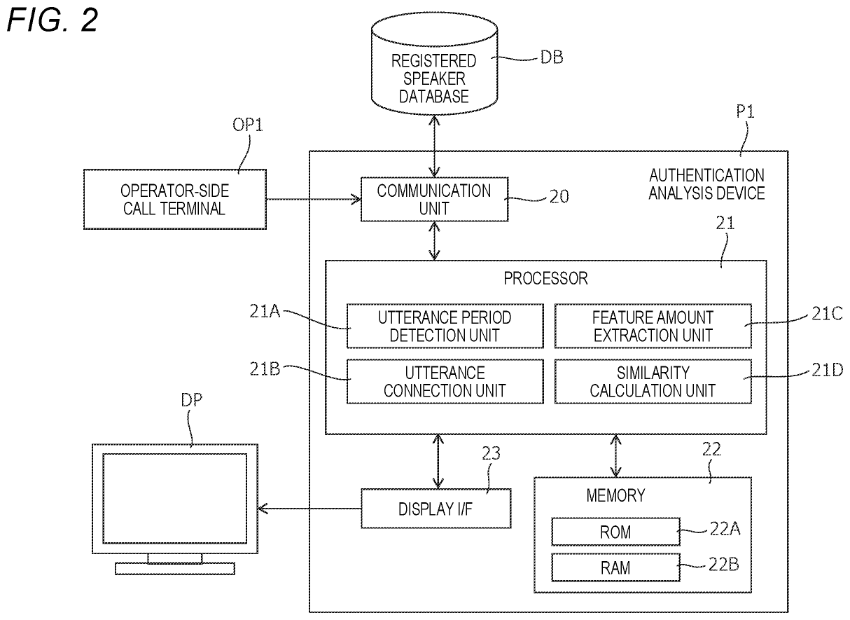

An example of an internal configuration of the authentication analysis device P1 will be described with reference to FIG. 2. FIG. 2 is a block diagram illustrating the example of the internal configuration of the authentication analysis device P1 according to Embodiment 1. The authentication analysis device P1 includes at least a communication unit 20, a processor 21, and a memory 22.

The communication unit 20, which is an example of an acquisition unit, is connected to the operator-side call terminal OP1 and the registered speaker database DB so as to be able to communicate data with each other. The communication unit 20 outputs the voice signals transmitted from the operator-side call terminal OP1 to the processor 21. The acquisition unit is not limited to the communication unit 20, and may be, for example, a microphone of the operator-side call terminal OP1 integrated with the authentication analysis device P1.

The processor 21 is implemented by a semi-conductor chip on which at least one of electronic devices such as a central processing unit (CPU), a digital signal processor (DSP), a graphical processing unit (GPU), and a field programmable gate array (FPGA) is mounted. The processor 21 functions as a controller that controls the overall operation of the authentication analysis device P1, and executes a control processing for controlling the operation of each part of the authentication analysis device P1, a data input and output processing between each part of the authentication analysis device P1, a data calculation processing, and a data storage processing.

The processor 21 uses a program and data stored in a read only memory (ROM) 22A of the memory 22 to implement functions of an utterance period detection unit 21A, an utterance connection unit 21B, a feature amount extraction unit 21C, and a similarity calculation unit 21D. The processor 21 uses a random access memory (RAM) 22B of the memory 22 during operation, and temporarily stores data or information generated or acquired by the processor 21 and each part in the RAM 22B of the memory 22.

The utterance period detection unit 21A, which is an example of a detection unit, a recognition unit, a conversion unit, and a noise detection unit, analyzes the acquired voice signals and detects utterance periods during which the user US is speaking. The utterance period detection unit 21A outputs a voice signal (hereinafter referred to as an “utterance voice signal”) corresponding to each utterance period detected based on the voice signal to the utterance connection unit 21B or the feature amount extraction unit 21C. In addition, the utterance period detection unit 21A may temporarily store the utterance voice signal of each utterance period in the RAM 22B of the memory 22.

When the utterance period detection unit 21A detects two or more utterance periods of the same person (user US) based on a voice signal, the utterance connection unit 21B, which is an example of a processing unit, connects utterance voice signals of the utterance periods. The utterance connection unit 21B outputs the connected utterance voice signals (hereinafter referred to as “a connected voice signal”) to the feature amount extraction unit 21C. A user authentication method will be described later.

The feature amount extraction unit 21C, which is an example of the processing unit, analyzes a feature of an individual voice extracted by the utterance period detection unit 21A using one or more utterance voice signals, for example, for each frequency, to extract an utterance feature amount. The feature amount extraction unit 21C may extract an utterance feature amount of the connected voice signal output from the utterance connection unit 21B. The feature amount extraction unit 21C outputs the extracted utterance feature amount and the utterance voice signals or the connected voice signal from which the utterance feature amount is extracted to the similarity calculation unit 21D in association with each other, or temporarily stores the utterance feature amount and the utterance voice signals or the connected voice signal in the RAM 22B of the memory 22.

The similarity calculation unit 21D, which is an example of an authentication unit, acquires the utterance feature amount of the utterance voice signals or the connected voice signal output from the feature amount extraction unit 21C. The similarity calculation unit 21D refers to the registered speaker database DB to calculate a similarity between the utterance feature amount of each of the plurality of users registered in the registered speaker database DB and the acquired utterance feature amount after the connection. The similarity calculation unit 21D specifies a user corresponding to the utterance voice signals or the connected voice signal (that is, the voice signals transmitted from the user-side call terminal UP1) based on the calculated similarity to execute user authentication.

When it is determined that the user is specified as a result of the user authentication, the similarity calculation unit 21D generates the authentication result screen SC including information related to the specified user (that is, an authentication result), and outputs the authentication result screen SC to the information display unit DP via a display interface (I/F) 23.

When it is determined that the calculated similarity is smaller than a predetermined value, the similarity calculation unit 21D determines that the user authentication is impossible, and may generate and output a control command for requesting the utterance connection unit 21B to connect utterance voice signals. In addition, when an upper limit number of times is set to the number of times of user authentication in the user authentication for the same person (user US) and it is determined that the number of times it has been determined that the user authentication is impossible is equal to or larger than the upper limit number of times, the similarity calculation unit 21D may generate an authentication result screen (not illustrated) notifying that the user authentication is impossible and output the authentication result screen to the information display unit DP.

The memory 22 includes, for example, at least the ROM 22A that stores a program defining various processes performed by the processor 21 and data to be used during the execution of the program, and the RAM 22B as a work memory to be used when the processor 21 executes various processes. The program defining various processes performed by the processor 21 and the data to be used during the execution of the program are written in the ROM 22A. The RAM 22B temporarily stores data or information generated or acquired by the processor 21 (for example, utterance voice signals before the connection, a connected voice signal after the connection, and an utterance feature amount corresponding to each utterance period before or after the connection).

The display I/F 23 connects the processor 21 and the information display unit DP so as to be able to communicate data with each other, and outputs the authentication result screen SC generated by the similarity calculation unit 21D of the processor 21 to the information display unit DP.

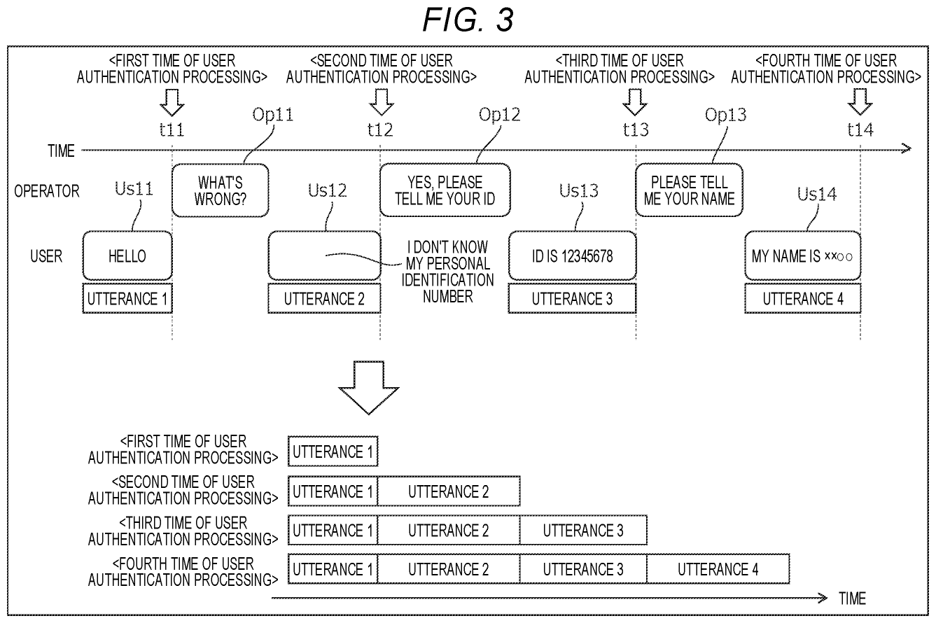

Next, a first user authentication processing executed by the authentication analysis device P1 will be described with reference to FIG. 3. FIG. 3 is a diagram illustrating an example of the first user authentication processing according to Embodiment 1. FIGS. 3 to 8 illustrate an example in which the operator OP and the user US who is a user authentication target are in conversation with each other.

The user-side call terminal UP1 collects an utterance voice Us11 of “Hello”, an utterance voice Us12 that “I don't know my personal identification number”, an utterance voice Us13 that “ID is 12345678”, and an utterance voice Us14 that “my name is ××∘∘” of the user US, converts the collected utterance voices into voice signals, and transmits the voice signals to the operator-side call terminal OP1.

The operator-side call terminal OP1 collects an utterance voice Op11 that “what's wrong?”, an utterance voice Op12 that “Yes, please tell me your ID”, and an utterance voice Op13 that “please tell me your name” of the operator OP, converts the utterance voices into voice signals, and transmits the voice signals to the user-side call terminal UP1. In addition, the operator-side call terminal OP1 acquires the voice signals transmitted from the user-side call terminal UP1 and transmits the voice signals to the authentication analysis device P1.

The utterance period detection unit 21A of the authentication analysis device P1 detects an utterance period of each of the utterance voices Us11 to Us14 of the user US based on the voice signal transmitted from the operator-side call terminal OP1. The utterance period detection unit 21A extracts an utterance voice signal corresponding to each detected utterance period. In the following description and FIGS. 3 to 8, the utterance voice signal corresponding to the utterance voice Us11 is referred to as an “utterance 1”, the utterance voice signal corresponding to the utterance voice Us12 is referred to as an “utterance 2”, the utterance voice signal corresponding to the utterance voice Us13 is referred to as an “utterance 3”, and the utterance voice signal corresponding to the utterance voice Us14 is referred to as an “utterance 4”.

It is needless to say that the conversation example between the operator OP and the user US illustrated in FIGS. 3 to 8 and the voice signal to be used for the user authentication are merely examples, and are not limited thereto. The acquisition of the voice signal to be used for the user authentication may be performed using a voice signal corresponding to an utterance voice collected after a timing when a predetermined word (for example, “start”) included in a voice signal is voice-recognized as the voice signal for user authentication. In addition, the utterance voice may be, for example, a voice including a plurality of sentences such as “Hello, I don't know my personal identification number”.

Hereinafter, the first user authentication processing will be described. In the first user authentication processing, when it is determined that the user authentication is impossible, the authentication analysis device P1 connects the utterance voice signals corresponding to the detected utterance periods in chronological order to execute the user authentication again.

The feature amount extraction unit 21C extracts an utterance feature amount of the utterance voice signal “utterance 1” corresponding to each extracted utterance period, and outputs the utterance feature amount to the similarity calculation unit 21D. The similarity calculation unit 21D executes user authentication by comparing the utterance feature amount of the utterance voice signal “utterance 1” output from the feature amount extraction unit 21C with the utterance feature amount of each of the plurality of users registered in the registered speaker database DB (first time of user authentication processing).

When it is determined that the user authentication is impossible based on the calculated similarity, the similarity calculation unit 21D causes the utterance connection unit 21B to connect the utterance voice signal “utterance 1” and the utterance voice signal “utterance 2”. The utterance connection unit 21B outputs a connected voice signal “utterance 1”+“utterance 2” after the connection to the feature amount extraction unit 21C. The feature amount extraction unit 21C extracts an utterance feature amount of the connected voice signal “utterance 1”+“utterance 2” after the connection, and outputs the utterance feature amount to the similarity calculation unit 21D. The similarity calculation unit 21D executes user authentication by comparing the utterance feature amount of the connected voice signal “utterance 1”+“utterance 2” output from the feature amount extraction unit 21C with the utterance feature amount of each of the plurality of users registered in the registered speaker database DB (second time of user authentication processing).

When it is determined that the user authentication is impossible based on the calculated similarity, the similarity calculation unit 21D causes the utterance connection unit 21B to connect the utterance voice signal “utterance 1”, the utterance voice signal “utterance 2”, and the utterance voice signal “utterance 3”. The utterance connection unit 21B outputs a connected voice signal “utterance 1”+“utterance 2”+“utterance 3” after the connection to the feature amount extraction unit 21C. The feature amount extraction unit 21C extracts an utterance feature amount of the connected voice signal “utterance 1”+“utterance 2”+“utterance 3” after the connection, and outputs the utterance feature amount to the similarity calculation unit 21D. The similarity calculation unit 21D executes user authentication by comparing the utterance feature amount of the connected voice signal “utterance 1”+“utterance 2”+“utterance 3” output from the feature amount extraction unit 21C with the utterance feature amount of each of the plurality of users registered in the registered speaker database DB (third time of user authentication processing).

When it is determined that the user authentication is impossible based on the calculated similarity, the similarity calculation unit 21D causes the utterance connection unit 21B to connect the utterance voice signal “utterance 1”, the utterance voice signal “utterance 2”, the utterance voice signal “utterance 3”, and the utterance voice signal “utterance 4”. The utterance connection unit 21B outputs a connected voice signal “utterance 1”+“utterance 2”+“utterance 3”+“utterance 4” after the connection to the feature amount extraction unit 21C. The feature amount extraction unit 21C extracts an utterance feature amount of the connected voice signal “utterance 1”+“utterance 2”+“utterance 3”+“utterance 4” after the connection, and outputs the utterance feature amount to the similarity calculation unit 21D. The similarity calculation unit 21D executes user authentication by comparing the utterance feature amount of the connected voice signal “utterance 1”+“utterance 2”+“utterance 3”+“utterance 4” output from the feature amount extraction unit 21C with the utterance feature amount of each of the plurality of users registered in the registered speaker database DB (fourth time of user authentication processing).

As described above, when the user authentication is executed by using the utterance voice signal corresponding to each utterance voice and it is determined that the user authentication is impossible, the authentication analysis device P1 sequentially connects the utterance voice signals in chronological order and increases a signal length (utterance voice length) of the connected voice signal to be used in the user authentication processing, whereby the personality of the utterance feature amount of the individual user US becomes stronger.

Accordingly, even when there is a variation in the utterance feature amounts of the user US included in the utterance voice signals, the personality of the utterance feature amount to be used for the user authentication appears more strongly, and thus the authentication analysis device P1 according to Embodiment 1 can improve the user authentication accuracy.

Accordingly, the authentication analysis device P1 according to Embodiment 1 can repeatedly execute the user authentication using the utterance voice signal of each utterance period detected based on the acquired voice signal. Therefore, when the user US is authenticated during a call (conversation) between the user US and the operator OP, the operator OP can more quickly turn up the call (conversation) with the user US.

In the example illustrated in FIG. 3, the user authentication processing is executed four times, and the authentication analysis device P1 may end the user authentication processing at a timing when it is determined that the user is authenticated. In addition, an upper limit number of times may be set for the user authentication processing, and when it is determined that the number of times of user authentication processing is the upper limit number of times, the authentication analysis device P1 may generate an authentication result screen (not illustrated) notifying that the user authentication is impossible and output the authentication result screen to the information display unit DP.

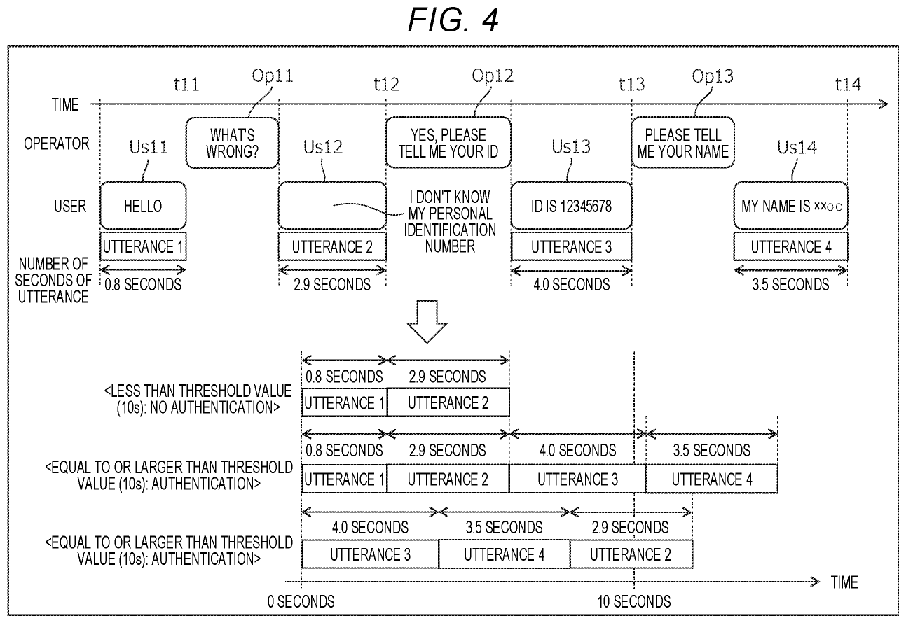

Next, a second user authentication processing executed by the authentication analysis device P1 will be described with reference to FIG. 4. FIG. 4 is a diagram illustrating an example of the second user authentication processing according to Embodiment 1.

In the second user authentication processing, the authentication analysis device P1 connects a plurality of utterance voice signals such that a signal length of the utterance voice signals to be used for the user authentication is equal to or longer than a predetermined time (for example, 5 seconds and 10 seconds), and executes the user authentication using the connected voice signal after the connection. In the example illustrated in FIG. 4, an example in which the predetermined time is 10 seconds will be described, and it is needless to say that the predetermined time is not limited thereto.

In the example illustrated in FIG. 4, the utterance period detection unit 21A detects each of the utterance voice signals “utterance 1” to “utterance 4” corresponding to each utterance period, and outputs the utterance voice signals to the utterance connection unit 21B. In FIG. 4, a signal length of the utterance voice signal “utterance 1” is 0.8 seconds, a signal length of the utterance voice signal “utterance 2” is 2.9 seconds, a signal length of the utterance voice signal “utterance 3” is 4.0 seconds, and a signal length of the utterance voice signal “utterance 4” is 3.5 seconds.

The utterance connection unit 21B connects the utterance voice signals “utterance 1” to “utterance 4” in combination so that a signal length of the utterance voice signals to be used for the user authentication becomes equal to or longer than the predetermined time. When a signal length of one utterance voice signal is a length equal to or longer than the predetermined time, the connection processing of the utterance voice signals by the utterance connection unit 21B may be omitted. The utterance connection unit 21B outputs the connected voice signal after the connection to the feature amount extraction unit 21C.

The feature amount extraction unit 21C acquires the utterance voice signals or the connected voice signal having a signal length equal to or longer than the predetermined time and output from the utterance period detection unit 21A or the utterance connection unit 21B. The feature amount extraction unit 21C extracts the utterance feature amount of the user US included in the acquired utterance voice signals or the acquired connected voice signal. The feature amount extraction unit 21C outputs the extracted utterance feature amount of the user US to the similarity calculation unit 21D.

The similarity calculation unit 21D acquires the utterance feature amount of the utterance voice signals or the connected voice signal output from the feature amount extraction unit 21C. The similarity calculation unit 21D refers to the registered speaker database DB to calculate the similarity between the utterance feature amount of each of the plurality of users registered in the registered speaker database DB and the acquired utterance feature amount. The similarity calculation unit 21D specifies a user corresponding to the acquired utterance voice signals or the acquired connected voice signal based on the calculated similarity to execute the user authentication.

For example, in the example illustrated in FIG. 4, a signal length of the connected voice signal “utterance 1”+“utterance 2” obtained by connecting the utterance voice signal “utterance 1” and the utterance voice signal “utterance 2” is 3.7 seconds (that is, smaller than the predetermined time (10 seconds)). In the second user authentication processing, the user authentication processing using the utterance voice signals after the connection having a signal length smaller than the predetermined time is not executed.

In addition, a signal length of the connected voice signal “utterance 1”+“utterance 2”+“utterance 3”+“utterance 4” obtained by connecting the utterance voice signals “utterance 1” to “utterance 4” is 11.2 seconds (that is, equal to or longer than the predetermined time (10 seconds)). Similarly, a signal length of the connected voice signal “utterance 3”+“utterance 4”+“utterance 2” obtained by connecting the utterance voice signals “utterance 2” to “utterance 4” is 10.4 seconds (that is, equal to or longer than the predetermined time (10 seconds)). In such a case, the authentication analysis device P1 executes the user authentication processing using the connected voice signal “utterance 1”+“utterance 2”+“utterance 3”+“utterance 4” or the connected voice signal “utterance 3”+“utterance 4”+“utterance 2”.

When it is determined that the user authentication is impossible, the authentication analysis device P1 generates a new connected voice signal by a combination of utterance voice signals that are different from a combination of the utterance voice signals already used for the user authentication to execute the user authentication again. For example, the authentication analysis device P1 executes the first time of user authentication processing using the connected voice signal “utterance 3”+“utterance 4”+“utterance 2”, and executes the second time of user authentication processing using the connected voice signal “utterance 1”+“utterance 2”+“utterance 3”+“utterance 4” when it is determined that the user authentication is impossible.

In the second user authentication processing, a connection order of the utterance voice signals may be a chronological order such as the connected voice signal “utterance 1”+“utterance 2”+“utterance 3”+“utterance 4”, or may be a descending order of the signal lengths of the utterance voice signals such as the connected voice signal “utterance 3”+“utterance 4”+“utterance 2”.

In the second user authentication processing, the utterance connection unit 21B may select utterance voice signals to be connected. When a lower limit time (for example, 2 seconds) is set as a reference for selecting an utterance voice signal to be connected, the utterance connection unit 21B may determine whether a signal length of the utterance voice signal corresponding to each utterance period output from the utterance period detection unit 21A is equal to or longer than the lower limit time. The utterance connection unit 21B executes the connection processing of the utterance voice signals using the utterance voice signals determined to have a signal length equal to or longer than the lower limit time.

Accordingly, the authentication analysis device P1 can remove, from the utterance voice signals to be used for the user authentication, an utterance voice signal that is a short utterance such as “Yes” or “Yeah” and has a small utterance feature amount of the individual user US. Therefore, the authentication analysis device P1 can execute the user authentication by using the connected voice signal having the utterance feature amount in which the personality appears more strongly, and thus can improve the user authentication accuracy.

As described above, the authentication analysis device P1 according to Embodiment 1 can improve the user authentication accuracy even when there is a variation in the utterance feature amounts of the user included in the utterance voice signals by using the connected voice signal having a signal length equal to or longer than the predetermined time and having an utterance feature amount more suitable for the user authentication processing.

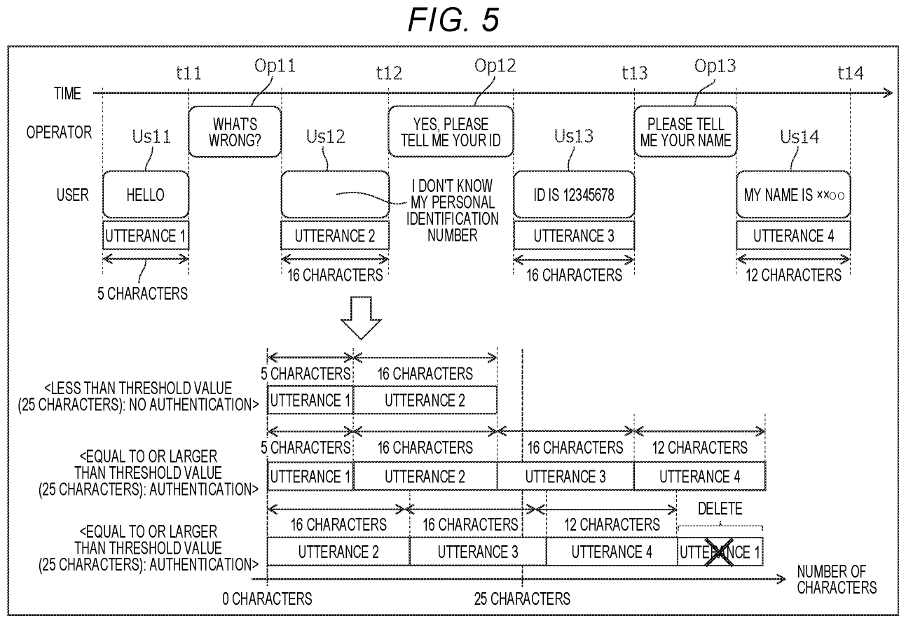

Next, a third user authentication processing executed by the authentication analysis device P1 will be described with reference to FIG. 5. FIG. 5 is a diagram illustrating an example of the third user authentication processing according to Embodiment 1.

In the third user authentication processing, the authentication analysis device P1 recognizes the number of characters included in the utterance voice signal to be used for the user authentication, connects a plurality of utterance voice signals so that the recognized number of characters is equal to or larger than a predetermined number of characters (for example, 20 characters and 25 characters), and executes the user authentication using the connected voice signal after the connection. In the example illustrated in FIG. 5, an example in which the predetermined number of characters=25 characters will be described, and it is needless to say that the predetermined number of characters is not limited thereto. Here, the number of characters may be the number of moras, the number of syllables, the number of phonemes, and the like.

In the example illustrated in FIG. 5, the utterance period detection unit 21A detects each of the utterance voice signals “utterance 1” to “utterance 4” corresponding to each utterance period, recognizes the number of characters included in each of the utterance voice signals, and outputs a recognition result and the utterance voice signals to the utterance connection unit 21B. In FIG. 5, the number of characters of the utterance voice signal “utterance 1” is 5 characters, the number of characters of each of the utterance voice signal “utterance 2” and the utterance voice signal “utterance 3” is 16 characters, and the number of characters of the utterance voice signal “utterance 4” is 12 characters.

The utterance connection unit 21B connects the utterance voice signals “utterance 1” to “utterance 4” in combination so that the number of characters of the utterance voice signals to be used for the user authentication becomes equal to or larger than the predetermined number of characters. When the number of characters of one utterance voice signal is equal to or larger than the predetermined number of characters, the connection processing of the utterance voice signals by the utterance connection unit 21B may be omitted. The utterance connection unit 21B outputs the connected voice signal after the connection to the feature amount extraction unit 21C.

The feature amount extraction unit 21C acquires utterance voice signals or a connected voice signal having a number of characters equal to or larger than the predetermined number of characters and output from the utterance period detection unit 21A or the utterance connection unit 21B. The feature amount extraction unit 21C extracts the utterance feature amount of the user US included in the acquired utterance voice signals or the acquired connected voice signal. The feature amount extraction unit 21C outputs the extracted utterance feature amount of the user US to the similarity calculation unit 21D.

The similarity calculation unit 21D acquires the utterance feature amount of the utterance voice signals or the connected voice signal output from the feature amount extraction unit 21C. The similarity calculation unit 21D refers to the registered speaker database DB to calculate a similarity between the utterance feature amount of each of the plurality of users registered in the registered speaker database DB and the acquired utterance feature amount after the connection. The similarity calculation unit 21D executes the user authentication based on the calculated similarity.

For example, in the example illustrated in FIG. 5, the number of characters of the connected voice signal “utterance 1”+“utterance 2” obtained by connecting the utterance voice signal “utterance 1” and the utterance voice signal “utterance 2” is 21 characters (that is, smaller than the predetermined number of characters (25 characters)). In the third user authentication processing, the user authentication processing using the connected voice signal in which the number of characters after the connection is smaller than the predetermined number of characters is not executed.

In addition, the number of characters of the connected voice signal “utterance 1”+“utterance 2”+“utterance 3”+“utterance 4” obtained by connecting the utterance voice signals “utterance 1” to “utterance 4” is 49 characters (that is, equal to or larger than the predetermined number of characters (25 characters)). Similarly, the number of characters of the connected voice signal “utterance 3”+“utterance 4”+“utterance 2” obtained by connecting the utterance voice signals “utterance 2” to “utterance 4” is 44 characters (that is, equal to or larger than the predetermined number of characters (25 characters)). The authentication analysis device P1 executes the user authentication processing using the connected voice signal “utterance 1”+“utterance 2”+“utterance 3”+“utterance 4” or the connected voice signal “utterance 3”+“utterance 4”+“utterance 2”.

When it is determined that the user authentication is impossible, the authentication analysis device P1 executes the user authentication again by using the new connected voice signal connected by a combination different from a combination of the utterance voice signals already used for the user authentication. For example, the authentication analysis device P1 executes the first time of user authentication processing using the connected voice signal “utterance 3”+“utterance 4”+“utterance 2”, and executes the second time of user authentication processing using the connected voice signal “utterance 1”+“utterance 2”+“utterance 3”+“utterance 4” when it is determined that the user authentication is impossible.

In the third user authentication processing, a connection order of the utterance voice signals may be a chronological order such as the connected voice signal “utterance 1” +“utterance 2”+“utterance 3”+“utterance 4”, or may be a descending order of the number of characters of the utterance voice signals such as the connected voice signal “utterance 3”+“utterance 4”+“utterance 2”.

In the third user authentication processing, the utterance connection unit 21B may select utterance voice signals to be connected. When a lower limit number of characters (for example, 5 characters) is set as a reference for selecting an utterance voice signal to be connected, the utterance connection unit 21B may determine whether the number of characters of the utterance voice signal corresponding to each of the utterance periods output from the utterance period detection unit 21A is equal to or larger than the lower limit number of characters. The utterance connection unit 21B executes the connection processing of the utterance voice signals using the utterance voice signals determined to have a number of characters equal to or larger than the lower limit number of characters.

Accordingly, the authentication analysis device P1 can remove, from the utterance voice signals to be used for the user authentication, an utterance voice signal that is an utterance having a small number of characters such as “Yes” or “Yeah” and has a small utterance feature amount of the individual user US. Therefore, the authentication analysis device P1 can execute the user authentication by using the utterance voice signals or the connected voice signal having the utterance feature amount in which the personality appears more strongly, and thus can improve the user authentication accuracy.

As described above, the authentication analysis device P1 according to Embodiment 1 can execute the user authentication processing by using the utterance voice signals or the connected voice signal having a number of characters equal to or larger than the predetermined number of characters and having the utterance feature amount more suitable for the user authentication processing.

Accordingly, the authentication analysis device P1 according to Embodiment 1 can improve the user authentication accuracy even when there is a variation in the utterance feature amounts of the user included in the utterance voice signals.

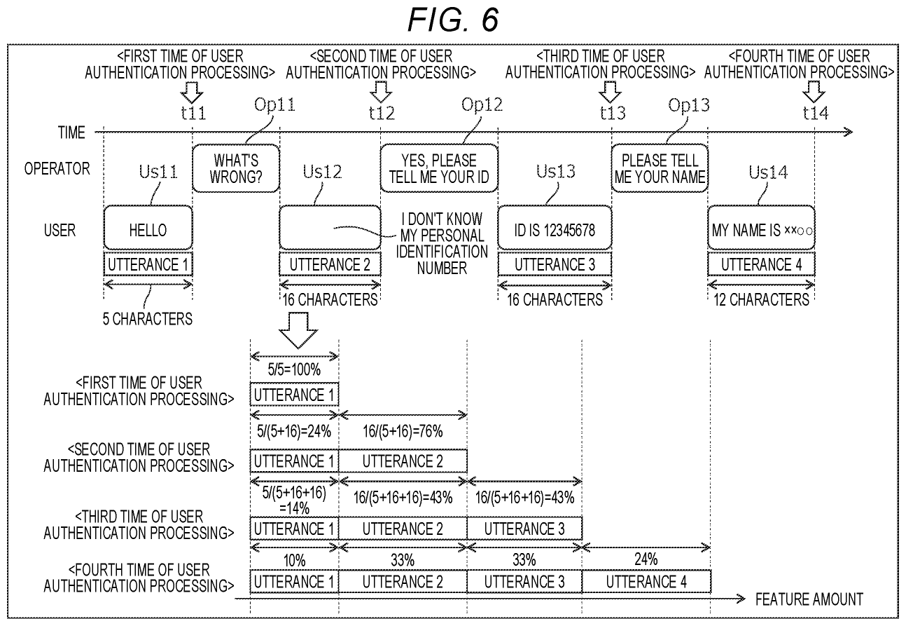

Next, a fourth user authentication processing executed by the authentication analysis device P1 will be described with reference to FIG. 6. FIG. 6 is a diagram illustrating an example of the fourth user authentication processing according to Embodiment 1.

In the fourth user authentication processing, the authentication analysis device P1 executes a weighting processing on each utterance voice signal based on the number of characters of the utterance voice signal. The authentication analysis device P1 executes the user authentication processing using the utterance feature amounts after the weighting processing.

In the example illustrated in FIG. 6, the utterance period detection unit 21A detects each of the utterance voice signals “utterance 1” to “utterance 4” corresponding to each utterance period, voice-recognizes the number of characters included in each of the utterance voice signals, and outputs a voice recognition result and the utterance voice signals to the utterance connection unit 21B. In FIG. 6, the number of characters of the utterance voice signal “utterance 1” is 5 characters, the number of characters of each of the utterance voice signal “utterance 2” and the utterance voice signal “utterance 3” is 16 characters, and the number of characters of the utterance voice signal “utterance 4” is 12 characters.

The utterance connection unit 21B determines a weighting factor of each utterance voice signal based on the utterance voice signals and the number of characters of each utterance voice signal voice-recognized by the utterance period detection unit 21A. The utterance connection unit 21B connects the utterance voice signals to generate a connected voice signal, and outputs the connected voice signal to the feature amount extraction unit 21C.

Specifically, the utterance connection unit 21B calculates a total number of characters of the two or more utterance voice signals to be connected, calculates a ratio of the number of characters of each utterance voice signal to the calculated total number of characters, and determines a weighting factor corresponding to the calculated ratio. The weighting factor corresponding to each utterance period may be output to and stored in the RAM 22B.

The feature amount extraction unit 21C executes a weighting processing on the utterance feature amount extracted from each utterance period based on each of the utterance voice signals of two or more utterance periods included in the connected voice signal output from the utterance connection unit 21B and the weighting factor corresponding to each utterance period. When the first time of user authentication processing is executed and no connected voice signal is generated, the calculation of the weighting factor and the weighting processing may be executed by the utterance period detection unit 21A, or the processing may be omitted.

Hereinafter, a specific example of the fourth user authentication processing will be described with reference to FIG. 6.

The utterance connection unit 21B determines the weighting factor to be 1.0 based on the voice-recognized number of characters (5 characters) of the utterance voice signal “utterance 1” and the total number of characters of the utterance voice signal (that is, the utterance voice signal “utterance 1”) to be used in the first time of user authentication processing. The utterance connection unit 21B outputs the utterance voice signal and the weighting factor to the feature amount extraction unit 21C.

The feature amount extraction unit 21C extracts the utterance feature amount of the utterance voice signal “utterance 1” output from the utterance connection unit 21B, weights the utterance feature amount of the extracted utterance voice signal “utterance 1” with the weighting factor, and outputs the weighted utterance feature amount to the similarity calculation unit 21D. The similarity calculation unit 21D executes the user authentication by comparing the utterance feature amount of the utterance voice signal “utterance 1” output from the feature amount extraction unit 21C with the utterance feature amount of each of the plurality of users registered in the registered speaker database DB (first time of user authentication processing).

When it is determined that the user authentication is impossible based on the calculated similarity, the similarity calculation unit 21D causes the utterance connection unit 21B to connect the utterance voice signal “utterance 1” and the utterance voice signal “utterance 2”. The utterance connection unit 21B determines weighting factors of the utterance voice signals “utterance 1” and “utterance 2”, respectively. The weighting factor of the utterance voice signal “utterance 1” is determined based on the number of characters (5 characters) of the utterance voice signal “utterance 1” and a total value (5+16) of the number of characters of the utterance voice signals, and the weighting factor of the utterance voice signal “utterance 2” is determined based on the number of characters (16 characters) of the utterance voice signal “utterance 2”, and a total value (5+16) of the number of characters of the utterance voice signals. In the example illustrated in FIG. 6, the utterance connection unit 21B determines the weighting factor of the utterance voice signal “utterance 1” to 0.24 and the weighting factor of the utterance voice signal “utterance 2” to 0.76. The utterance connection unit 21B outputs the connected voice signal and the weighting factors to the feature amount extraction unit 21C.

The feature amount extraction unit 21C extracts the utterance feature amounts of the utterance voice signal “utterance 1” and the utterance voice signal “utterance 2” output from the utterance connection unit 21B. The feature amount extraction unit 21C weights the extracted utterance feature amounts of the utterance voice signals “utterance 1” and “utterance 2” with the weighting factors, and outputs the utterance feature amounts to the similarity calculation unit 21D. The similarity calculation unit 21D executes the user authentication by comparing the utterance feature amount of the connected voice signal “utterance 1”+“utterance 2” output from the feature amount extraction unit 21C with the utterance feature amount of each of the plurality of users registered in the registered speaker database DB (second time of user authentication processing).

When it is determined that the user authentication is impossible based on the calculated similarity, the similarity calculation unit 21D causes the utterance connection unit 21B to connect the utterance voice signal “utterance 1”, the utterance voice signal “utterance 2”, and the utterance voice signal “utterance 3”. The utterance connection unit 21B determines weighting factors of the utterance voice signals “utterance 1”, “utterance 2”, and “utterance 3”, respectively. The weighting factor of the utterance voice signal “utterance 1” is determined based on the number of characters (5 characters) of the utterance voice signal “utterance 1” and a total value (5+16+16) of the number of characters of the utterance voice signals, the weighting factor of the utterance voice signal “utterance 2” is determined based on the number of characters the number of characters (16 characters) of the utterance voice signal “utterance 2” and a total value (5+16+16) of the number of characters of the utterance voice signals, and the weighting factor of the utterance voice signal “utterance 3” is determined based on the number of characters (16 characters) of the utterance voice signal “utterance 3” and a total value (5+16+16) of the number of characters of the utterance voice signals. In the example illustrated in FIG. 6, the utterance connection unit 21B determines the weighting factor of the utterance voice signal “utterance 1” to 0.14, the weighting factor of the utterance voice signal “utterance 2” to 0.43, and the weighting factor of the utterance voice signal “utterance 3” to 0.43. The utterance connection unit 21B outputs the connected voice signal and the weighting factors to the feature amount extraction unit 21C.

The feature amount extraction unit 21C extracts the utterance feature amounts of the utterance voice signal “utterance 1”, the utterance voice signal “utterance 2”, and the utterance voice signal “utterance 3” output from the utterance connection unit 21B. The feature amount extraction unit 21C weights the extracted utterance feature amounts of the utterance voice signals “utterance 1” to “utterance 3” with the weighting factors, and outputs the utterance feature amounts to the similarity calculation unit 21D. The similarity calculation unit 21D executes the user authentication by comparing the utterance feature amount of the connected voice signal “utterance 1”+“utterance 2”+“utterance 3” output from the feature amount extraction unit 21C with the utterance feature amount of each of the plurality of users registered in the registered speaker database DB (third time of user authentication processing).

When it is determined that the user authentication is impossible based on the calculated similarity, the similarity calculation unit 21D causes the utterance connection unit 21B to connect the utterance voice signal “utterance 1”, the utterance voice signal “utterance 2”, the utterance voice signal “utterance 3”, and the utterance voice signal “utterance 4”. The utterance connection unit 21B determines weighting factors of the utterance voice signals “utterance 1”, “utterance 2”, “utterance 3”, and “utterance 4”, respectively. The weighting factor of the utterance voice signal “utterance 1” is determined based on the number of characters (5 characters) of the utterance voice signal “utterance 1” and a total value (5+16+16+12) of the number of characters of the utterance voice signals. The weighting factor of the utterance voice signal “utterance 2” is determined based on the number of characters (16 characters) of the utterance voice signal “utterance 2” and a total value (5+16+16+12) of the number of characters of the utterance voice signals. The weighting factor of the utterance voice signal “utterance 3” is determined based on the number of characters (16 characters) of the utterance voice signal “utterance 3” and a total value (5+16+16+12) of the number of characters of the utterance voice signals. The weighting factor of the utterance voice signal “utterance 4” is determined based on the number of characters (12 characters) of the utterance voice signal “utterance 4” and a total value (5+16+16+12) of the number of characters of the utterance voice signals. In the example illustrated in FIG. 6, the utterance connection unit 21B determines the weighting factor of the utterance voice signal “utterance 1” to 0.10, the weighting factor of the utterance voice signal “utterance 2” to 0.33, the weighting factor of the utterance voice signal “utterance 3” to 0.33, and the weighting factor of the utterance voice signal “utterance 4” to 0.24. The utterance connection unit 21B outputs the connected voice signal and the weighting factors to the feature amount extraction unit 21C.

The feature amount extraction unit 21C extracts the utterance feature amounts of the utterance voice signal “utterance 1”, the utterance voice signal “utterance 2”, the utterance voice signal “utterance 3”, and the utterance voice signal “utterance 4” output from the utterance connection unit 21B. The feature amount extraction unit 21C weights the extracted utterance feature amounts of the utterance voice signals “utterance 1” to “utterance 4” with the weighting factors, and outputs the utterance feature amounts to the similarity calculation unit 21D. The similarity calculation unit 21D executes the user authentication by comparing the utterance feature amount of the connected voice signal “utterance 1”+“utterance 2”+“utterance 3”+“utterance 4” output from the feature amount extraction unit 21C with the utterance feature amount of each of the plurality of users registered in the registered speaker database DB (fourth time of user authentication processing).

In the above example of the fourth user authentication processing, an example in which the weighting factors are determined based on the number of characters has been described, and the present invention is not limited thereto. For example, the weighting factor may be determined based on the number of moras, the number of syllables, and the number of phonemes. In addition, a calculation example of the weighting factor described above is an example, and it is needless to say that the calculation example is not limited thereto.

As described above, the authentication analysis device P1 according to Embodiment 1 can execute the user authentication processing using the utterance voice signal having the utterance feature amount more suitable for the user authentication processing by executing the weighting processing on the utterance feature amount of the utterance voice signal.

Accordingly, the authentication analysis device P1 according to Embodiment 1 can improve the user authentication accuracy even when there is a variation in the utterance feature amounts of the user included in the utterance voice signals.

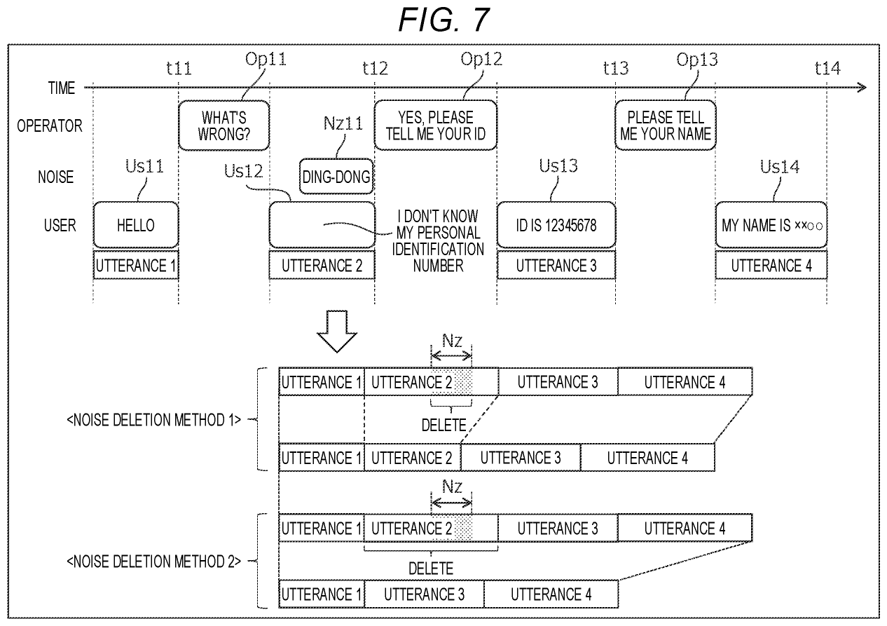

Next, a fifth user authentication processing executed by the authentication analysis device P1 will be described with reference to FIG. 7. FIG. 7 is a diagram illustrating an example of the fifth user authentication processing according to Embodiment 1.

In the fifth user authentication processing, the utterance period detection unit 21A of the authentication analysis device P1 performs voice analysis on the utterance voice signals and detects a period (hereinafter, referred to as a “noise period”) including a noise (for example, a voice, a noise, and an environmental sound other than the user US) included in the utterance voice signals. The utterance period detection unit 21A deletes the detected noise period from the utterance voice signals, or deletes the utterance voice signal corresponding to the utterance period including the noise period from the connected voice signal. The authentication analysis device P1 executes the user authentication processing using the utterance voice signal or the connected voice signal after the deletion processing.

The utterance voice Us12 illustrated in FIG. 7 includes a noise Nz11 “ding-dong” which is an environmental sound of the user US. In such a case, the utterance period detection unit 21A detects the utterance voice signals “utterance 1” to “utterance 4” corresponding to the utterance periods, detects the noise Nz11 based on the connected voice signal obtained by connecting the detected utterance voice signals “utterance 1” to “utterance 4”, and detects a noise period Nz including the noise Nz11.

The utterance period detection unit 21A deletes the detected noise period Nz from the utterance voice signal “utterance 2”, and generates a connected voice signal obtained by connecting the utterance voice signal “utterance 2” after the noise period Nz is deleted and the utterance voice signals “utterance 1”, “utterance 3”, and “utterance 4” corresponding to the utterance periods.

In addition, the utterance period detection unit 21A deletes the utterance voice signal “utterance 2” including the noise period Nz, and generates a connected voice signal obtained by connecting the utterance voice signals “utterance 1”, “utterance 3”, and “utterance 4” not including the noise period Nz.

Here, an example in which the utterance period detection unit 21A detects and removes the noise period Nz from the connected voice signal will be described, but the same applies to the case of detecting and removing the noise period Nz from the utterance voice signal.

As described above, the authentication analysis device P1 according to Embodiment 1 can execute the user authentication processing using the utterance voice signals having the utterance feature amount more suitable for the user authentication processing by removing the noise included in the utterance voice signal. Accordingly, the authentication analysis device P1 according to Embodiment 1 can improve the user authentication accuracy.

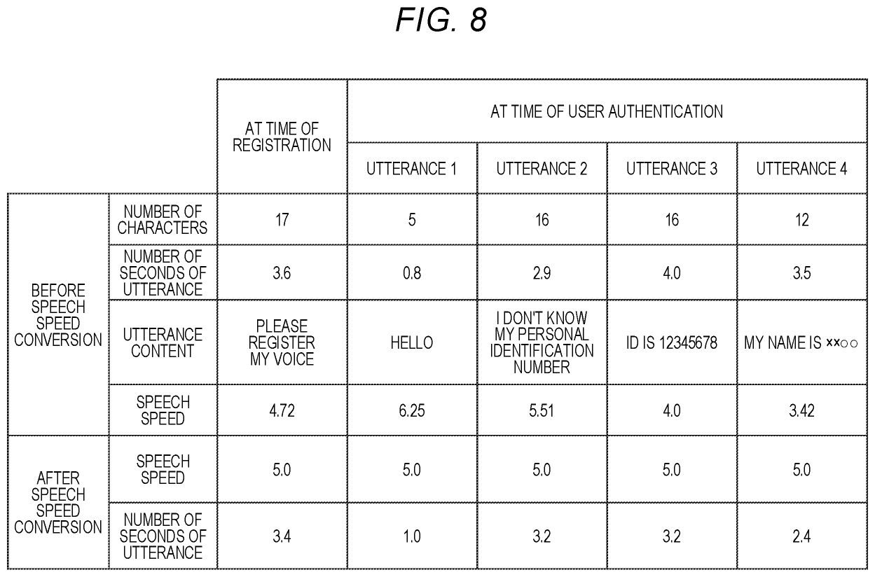

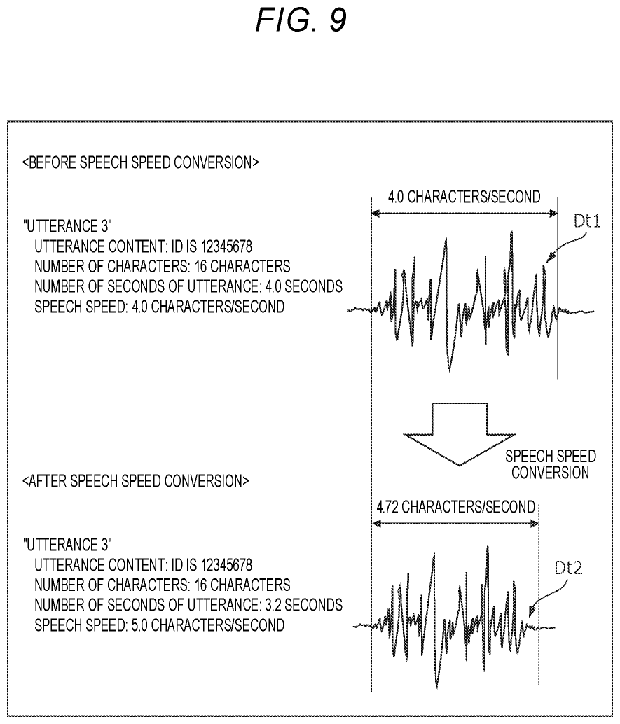

Next, a sixth user authentication processing executed by the authentication analysis device P1 will be described with reference to FIGS. 8 and 9. FIG. 8 is a diagram illustrating an example of the sixth user authentication method according to Embodiment 1. FIG. 9 is a diagram illustrating an example of the sixth user authentication method according to Embodiment 1.

In the sixth user authentication processing, the utterance period detection unit 21A of the authentication analysis device P1 performs voice analysis on the utterance voice signal to recognize the number of characters, and calculates a speech speed (that is, the number of characters per second) of the utterance voice signal. The utterance period detection unit 21A executes processing (hereinafter referred to as a “speech speed conversion processing”) of reducing or extending the utterance voice signal such that the speech speed of the utterance voice signal becomes a predetermined speech speed. For example, in the example illustrated in FIG. 9, an utterance voice signal Dt1 is converted into an utterance voice signal Dt2 by the speech speed conversion processing. The authentication analysis device P1 executes the user authentication using the utterance voice signals after the speech speed conversion processing or the connected voice signal obtained by connecting the utterance voice signals after the speech speed conversion processing.

When speech speeds of extraction source data (that is, the utterance voice signals) of the utterance feature amounts of the plurality of users registered (stored) in the registered speaker database DB are the same speech speed (for example, the speech speed=5.0 characters/second illustrated in FIG. 8), the utterance period detection unit 21A sets the same speech speed as the predetermined speech speed and executes the speech speed conversion processing. Accordingly, the authentication analysis device P1 can more accurately calculate the similarity between the utterance feature amount of the utterance voice signals or the connected voice signal to be used for the user authentication and the utterance feature amount of each user registered in the registered speaker database DB, and thus can further improve the user authentication accuracy.

Hereinafter, an example of the speech speed conversion processing of each of the utterance voice signals “utterance 1” to “utterance 4” of the user US will be specifically described with reference to FIG. 8.

For example, at the time of registration of the voice (utterance feature amount) of the user US, an utterance voice signal of the user US to be used for registration (storage) in the registered speaker database DB has the number of characters=17 characters, the number of seconds of utterance (that is, an utterance period)=3.6 seconds, an utterance content that “please register my voice”, and a speech speed=4.72 characters/second. In such a case, the utterance voice signal of the user US at the speech speed of 4.72 characters/second is registered (stored) in the registered speaker database DB in a state of being subjected to the speech speed conversion processing for converting the utterance voice signal into an utterance voice signal having a predetermined speech speed of 5.0 characters/second. The speech speed conversion processing at the time of registration (storage) in the registered speaker database DB may be executed by the authentication analysis device P1.

At the time of user authentication, the utterance voice signal “utterance 1” of the user US has the number of characters=5 characters, the number of seconds of utterance=0.8 seconds, an utterance content of “Hello”, and a speech speed=6.25 characters/second. The utterance voice signal “utterance 2” has the number of characters=16 characters, the number of seconds of utterance=2.9 seconds, an utterance content that “I don't know my personal identification number”, and a speech speed=5.51 characters/second. The utterance voice signal “utterance 3” has the number of characters=16 characters, the number of seconds of utterance=4.0 seconds, an utterance content that “ID is 12345678”, and a speech speed=4.0 characters/second. The utterance voice signal “utterance 4” has the number of characters=12 characters, the number of seconds of utterance=3.5 seconds, an utterance content that “my name is ××∘∘”, and a speech speed=3.42 characters/second.

Each of the utterance voice signals “utterance 1” to “utterance 4” is subjected to speech speed conversion to the predetermined speech speed of 5.0 characters/second when being registered (stored) in the registered speaker database DB, and is registered (stored). Accordingly, the utterance voice signal “utterance 1” is converted into an utterance voice signal having the number of seconds of utterance=1.0 seconds. Similarly, each of the utterance voice signals “utterance 2” and “utterance 3” is converted into an utterance voice signal having the number of seconds of utterance=3.2 seconds. The utterance voice signal “utterance 4” is converted into an utterance voice signal having the number of seconds of utterance=2.4 seconds.

The speech speed of the utterance voice signal may be calculated based on the number of characters and the number of seconds of utterance acquired from a voice recognition result of the utterance voice signals, or may be estimated based on the number of moras, the number of syllables, or the number of phonemes and the number of seconds of utterance. In addition, the speech speed of the utterance voice signal may be directly estimated by a calculation processing based on a time component and a frequency component of the voice signal.

As described above, the authentication analysis device P1 according to Embodiment 1 can more accurately calculate the similarity between the utterance feature amount of the utterance voice signals or the connected voice signal to be used for the user authentication and the utterance feature amount of each user registered in the registered speaker database DB by executing the user authentication processing using the utterance voice signals whose speech speeds are converted into the predetermined speech speed even when the speech speed of the user US varies, and thus can further improve the user authentication accuracy.

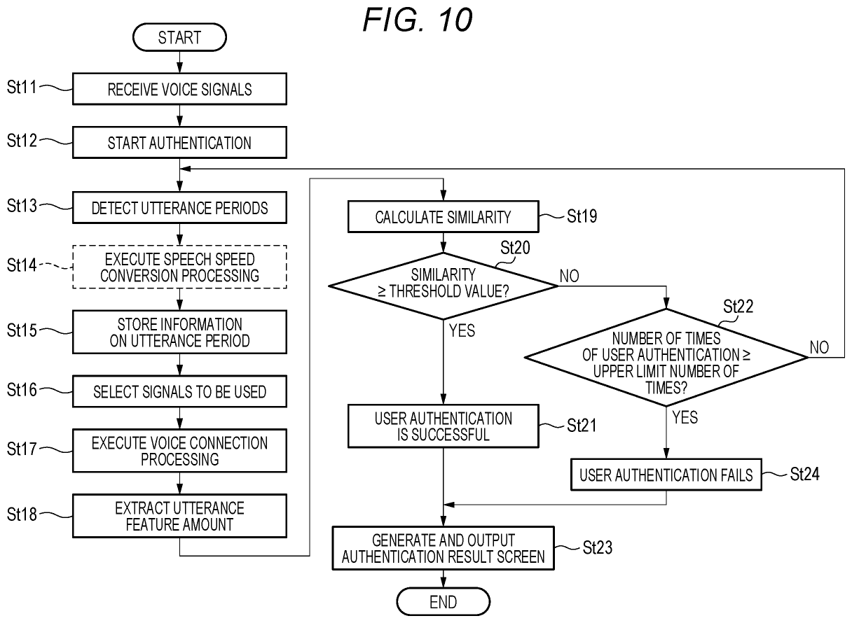

Next, an example of an operation procedure of the authentication analysis device P1 will be described with reference to FIG. 10. FIG. 10 is a flowchart illustrating the example of the operation procedure of the authentication analysis device P1 according to Embodiment 1.

The communication unit 20 of the authentication analysis device P1 acquires voice signals (or voice data) transmitted from the operator-side call terminal OP1 (St11). The communication unit 20 outputs the acquired voice signals to the processor 21.

The processor 21 starts authentication of the user US who is a voice authentication target of the acquired voice signals at a timing when the voice signals output from the communication unit 20 are acquired (St12).

The utterance period detection unit 21A of the processor 21 detects utterance periods based on the acquired voice signals (St13).

The utterance period detection unit 21A voice-recognizes the number of characters included in the utterance voice signal corresponding to the utterance period. The utterance period detection unit 21A calculates a speech speed of the utterance voice signal based on the voice-recognized number of characters and a signal length (an utterance voice length, the number of seconds of utterance, and the like) of the utterance voice signal. The utterance period detection unit 21A executes a speech speed conversion processing on the utterance voice signal, and converts the speech speed of the utterance voice signal into a predetermined speech speed (St14). The processing of step St14 may not be essential and may be omitted.

The utterance period detection unit 21A stores in the memory 22 information on the detected utterance period (for example, a start time and an end time of the utterance period, the number of characters, the signal length (the utterance voice length, the number of seconds of utterance, and the like), and the speech speed before or after speech speed conversion) (St15).

The utterance period detection unit 21A selects one or more utterance voice signals to be used for the user authentication based on a currently set user authentication processing method (St16). Although not illustrated in FIG. 10, when it is determined that there is no utterance voice signal to be used for the user authentication based on the currently set user authentication processing method, the authentication analysis device P1 may return to the processing of step St13 to detect a new utterance period.

The utterance period detection unit 21A executes a voice connection processing of connecting the selected one or more utterance voice signals to generate a connected voice signal (St17). The processing of step St17 is omitted when a first user authentication processing method is set and before the first time of user authentication is executed. The utterance period detection unit 21A outputs the generated connected voice signal to the feature amount extraction unit 21C.

The feature amount extraction unit 21C extracts the utterance feature amount of the individual user US from the connected voice signal output from the utterance period detection unit 21A (St18). The feature amount extraction unit 21C outputs the extracted utterance feature amounts of the individual user US to the similarity calculation unit 21D.

The similarity calculation unit 21D refers to the utterance feature amount of each of the plurality of users registered in the registered speaker database DB, and calculates the similarity between the utterance feature amount of the individual user US output from the feature amount extraction unit 21C and the utterance feature amount of each of the plurality of users registered in the registered speaker database DB (St19).

The similarity calculation unit 21D determines whether there is a user whose calculated similarity is equal to or larger than a threshold value among the plurality of users registered in the registered speaker database DB (St20).

When it is determined in the processing at Step St19 that there is a user whose calculated similarity is equal to or larger than the threshold value among the plurality of users registered in the registered speaker database DB (St20, YES), the similarity calculation unit 21D determines that the user is the user US of the voice signal (St21). When it is determined that there are a plurality of users whose similarities are equal to or larger than the threshold value, the similarity calculation unit 21D may determine that a user having the highest similarity is the user US of the voice signal.

When it is determined that the user is specified, the similarity calculation unit 21D generates the authentication result screen SC including information related to the specified user (that is, an authentication result), and outputs the authentication result screen SC to the information display unit DP via the display I/F 23 (St23).

On the other hand, when it is determined in the processing of step St19 that there is no user whose calculated similarity is equal to or larger than the threshold value among the plurality of users registered in the registered speaker database DB (St20, NO), the similarity calculation unit 21D determines whether the current number of times of user authentication processing is equal to or larger than the set upper limit number of times (St22).

When it is determined in the processing of step St22 that the current number of times of user authentication processing is equal to or larger than the set upper limit number of times (St22, YES), the similarity calculation unit 21D determines that the user authentication is impossible (that is, the user authentication fails) based on the acquired voice signal (St24). The similarity calculation unit 21D generates an authentication result screen (not illustrated) notifying that the user authentication is impossible, and transmits the authentication result screen to the information display unit DP via the display I/F 23. The information display unit DP outputs (displays) the authentication result screen transmitted from the authentication analysis device P1.

When it is determined in the processing of step St22 that the current number of times of user authentication processing is smaller than the set upper limit number of times (St22, NO), the similarity calculation unit 21D returns to the processing of step St13.

As described above, the authentication analysis device P1 according to Embodiment 1 can execute the user authentication processing using the utterance voice signal more suitable for the user authentication processing by using a predetermined user authentication processing method. Accordingly, the authentication analysis device P1 according to Embodiment 1 can improve the user authentication accuracy.

As described above, the authentication analysis device P1 according to Embodiment 1 includes the communication unit 20 (an example of the acquisition unit) that acquires the voice signal of the utterance voice of the speaker (for example, the user US), the utterance period detection unit 21A (an example of the detection unit) that detects a first utterance period during which the speaker is speaking based on the acquired voice signal, and the similarity calculation unit 21D (an example of the authentication unit) that authenticates the speaker (that is, executes the user authentication) based on a comparison between an utterance voice signal (an example of the voice signal) of the first utterance period detected by the utterance period detection unit 21A and the registered speaker database DB (an example of the database). When it is determined by the similarity calculation unit 21D that the speaker authentication is impossible, the utterance period detection unit 21A detects a second utterance period different from the first utterance period. The similarity calculation unit 21D authenticates the speaker based on a comparison between the utterance voice signal of the first utterance period and an utterance voice signal of the second utterance period, and the registered speaker database DB. The one or more computers include at least the authentication analysis device P1.

Accordingly, when it is determined that the user authentication is impossible using the utterance voice signal of one utterance period (the first utterance period), the authentication analysis device P1 according to Embodiment 1 can extract the utterance feature amount in which the personality appears more strongly by sequentially connecting the utterance voice signals in chronological order and increasing a signal length (utterance voice length) of the connected voice signal to be used for the user authentication processing. Therefore, the authentication analysis device P1 according to Embodiment 1 can extract the utterance feature amount in which the personality to be used for the user authentication appears more strongly even when there is a variation in the utterance feature amounts of the user included in the utterance voice signals, and thus can improve the user authentication accuracy.

The utterance period detection unit 21A of the authentication analysis device P1 according to Embodiment 1 detects the first utterance period and the second utterance period in time series of the acquired voice signals. Accordingly, the authentication analysis device P1 according to Embodiment 1 can execute the user authentication processing again by using the utterance voice signals of the plurality of utterance periods sequentially detected in the time series of the voice signals.

In Embodiment 1, the first utterance period and the second utterance period are two continuous utterance periods detected by the utterance period detection unit 21A. Accordingly, when it is determined that the user authentication is impossible using the utterance voice signal of one utterance period (that is, the first utterance period), the utterance feature amount in which the personality appears more strongly can be extracted by sequentially connecting the utterance voice signals in chronological order and increasing the signal length (utterance voice length) of the connected voice signal to be used for the user authentication processing. Accordingly, the authentication analysis device P1 according to Embodiment 1 can extract the utterance feature amount in which the personality to be used for the user authentication appears more strongly even when there is a variation in the utterance feature amounts of the user included in the utterance voice signals, and thus can improve the user authentication accuracy.

In Embodiment 1, a total length of the first utterance period and the second utterance period is equal to or longer than a first predetermined time (for example, equal to or longer than 5 seconds). Accordingly, the authentication analysis device P1 according to Embodiment 1 can improve the user authentication accuracy even when there is a variation in the utterance feature amounts of the user included in the utterance voice signals by using the connected voice signal having a signal length equal to or longer than the first predetermined time.

In the authentication analysis device P1 according to Embodiment 1, a length of each of the first utterance period and the second utterance period is equal to or longer than a second predetermined time (for example, equal to or longer than 10 seconds). Accordingly, the authentication analysis device P1 according to Embodiment 1 can remove, from the utterance voice signals to be used for the user authentication, an utterance voice signal that is a short utterance such as “Yes” or “Yeah” and has a small utterance feature amount of the individual user US. Therefore, the authentication analysis device P1 can execute the user authentication by using the connected voice signal having the utterance feature amount in which the personality appears more strongly, and thus can improve the user authentication accuracy. In addition, the authentication analysis device P1 according to Embodiment 1 can improve the user authentication accuracy even when there is a variation in the utterance feature amounts of the user included in the utterance voice signals by using the connected voice signal having a signal length equal to or longer than the predetermined time and having the utterance feature amount more suitable for the user authentication processing.

The authentication analysis device P1 according to Embodiment 1 further includes the utterance period detection unit 21A (an example of the recognition unit) that voice-recognizes a first number of characters included in the first utterance period and a second number of characters included in the second utterance period. A total number of characters included in the first utterance period and the second utterance period is equal to or larger than a first predetermined number of characters (for example, 25 characters). Accordingly, the authentication analysis device P1 according to Embodiment 1 can execute the user authentication processing by using the utterance voice signals or the connected voice signal having the number of characters equal to or larger than the predetermined number of characters and having the utterance feature amount more suitable for the user authentication processing. Therefore, the authentication analysis device P1 can execute the user authentication by using the utterance voice signals or the connected voice signal having the utterance feature amount in which the personality appears more strongly, and thus can improve the user authentication accuracy.

In the authentication analysis device P1 according to Embodiment 1, the number of characters included in each of the first utterance period and the second utterance period is equal to or larger than a second predetermined number of characters (for example, equal to or larger than 5 characters). Accordingly, the authentication analysis device P1 according to Embodiment 1 can remove, from the utterance voice signals to be used for the user authentication, an utterance voice signal that is an utterance having a small number of characters such as “Yes” or “Yeah” and has a small utterance feature amount of the individual user US. Therefore, the authentication analysis device P1 can execute the user authentication by using the utterance voice signals or the connected voice signal having the utterance feature amount in which the personality appears more strongly, and thus can improve the user authentication accuracy.

The authentication analysis device P1 according to Embodiment 1 further includes the utterance period detection unit 21A that voice-recognizes the first number of characters included in the first utterance period and the second number of characters included in the second utterance period. The similarity calculation unit 21D weights the utterance voice signal of the first utterance period based on the first number of characters, weights the utterance voice signal of the second utterance period based on the second number of characters, and authenticates the speaker based on a comparison between the weighted utterance voice signals of the first utterance period and the second utterance period, and the registered speaker database DB. Accordingly, the authentication analysis device P1 according to Embodiment 1 can execute the user authentication processing using the utterance voice signal having the utterance feature amount more suitable for the user authentication processing by executing the weighting processing on each utterance voice signal based on a ratio of the number of characters included in each utterance voice signal to the total number of characters of the connected voice signal to be used for the user authentication processing. Therefore, the authentication analysis device P1 according to Embodiment 1 can improve the user authentication accuracy even when there is a variation in the utterance feature amounts of the user included in the utterance voice signals.

The authentication analysis device P1 according to Embodiment 1 further includes the utterance connection unit 21B and the feature amount extraction unit 21C (an example of the processing unit) that weight each of the first utterance period and the second utterance period based on the first number of characters and the second number of characters voice-recognized by the utterance period detection unit 21A. The utterance connection unit 21B calculates the total number of characters based on the first number of characters and the second number of characters, weights the first utterance period based on a ratio of the first number of characters to the total number of characters, and weights the second utterance period based o a ratio of the second number of characters to the total number of characters. The similarity calculation unit 21D authenticates the speaker based on a comparison between the utterance voice signals of the weighted first utterance period and the weighted second utterance period, and the registered speaker database DB. Accordingly, the authentication analysis device P1 according to Embodiment 1 can more accurately calculate the similarity between the utterance feature amount of the utterance voice signals or the connected voice signal to be used for the user authentication and the utterance feature amount of each user registered in the registered speaker database DB by executing the user authentication processing using the utterance voice signals whose speech speeds are converted into the predetermined speech speed even when the speech speed of the user US varies, and thus can further improve the user authentication accuracy.

The authentication analysis device P1 according to Embodiment 1 further includes the utterance period detection unit 21A (an example of the noise detection unit) that detects the noise period Nz included in the utterance voice signals of the first utterance period and the second utterance period. The similarity calculation unit 21D deletes the detected noise period Nz from the first utterance period and the second utterance period, and authenticates the speaker based on a comparison between the utterance voice signals of the first utterance period and the second utterance period from which the noise period Nz is deleted, and the registered speaker database DB. Accordingly, the authentication analysis device P1 according to Embodiment 1 can execute the user authentication processing using the utterance voice signal having the utterance feature amount more suitable for the user authentication processing by removing the noise included in the utterance voice signals, and can improve the user authentication accuracy.

The similarity calculation unit 21D according to Embodiment 1 deletes the first utterance period or the second utterance period including the noise period Nz. When both the first utterance period and the second utterance period are deleted, the utterance period detection unit 21A detects a third utterance period different from the first utterance period and the second utterance period. When no noise period Nz is detected from an utterance voice signal of the third utterance period by the utterance period detection unit 21A, the similarity calculation unit 21D authenticates the speaker based on a comparison between the utterance voice signal of the third utterance period and the registered speaker database DB. Accordingly, the authentication analysis device P1 according to Embodiment 1 can execute the user authentication processing using the utterance voice signal having the utterance feature amount more suitable for the user authentication processing by removing the noise period Nz included in the utterance voice signal, and thus can improve the user authentication accuracy.

The similarity calculation unit 21D according to Embodiment 1 deletes the first utterance period or the second utterance period including the noise period Nz. The utterance period detection unit 21A detects the third utterance period different from the first utterance period and the second utterance period when one of the first utterance period and the second utterance period is deleted. When no noise period is detected from the utterance voice signal of the third utterance period by the noise detection unit, the similarity calculation unit 21D authenticates the speaker based on a comparison between the utterance voice signal of the third utterance period and the utterance voice signal of the other of the first utterance period and the second utterance period not including the noise period Nz, and the registered speaker database DB. Accordingly, the authentication analysis device P1 according to Embodiment 1 can execute the user authentication processing using the utterance voice signal having the utterance feature amount more suitable for the user authentication processing by removing the utterance period including a noise, and thus can improve the user authentication accuracy.

The number of characters in Embodiment 1 is the number of moras, the number of syllables, or the number of phonemes. Accordingly, the authentication analysis device P1 according to Embodiment 1 can determine the utterance voice signals or the connected voice signal having the utterance feature amount more suitable for the user authentication processing based on the number of moras, the number of syllables, or the number of phonemes. Therefore, the authentication analysis device P1 can improve the user authentication accuracy even when there is a variation in the utterance feature amounts of the user included in the utterance voice signals.

Although various embodiments have been described above with reference to the drawings, it is needless to say that the present disclosure is not limited to these embodiments. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be combined freely in a range without deviating from the spirit of the invention.

The present application is based on Japanese Patent Application No. 2021-157045 filed on Sep. 27, 2021, and the contents thereof are incorporated herein by reference.

### Industrial Applicability

The present disclosure is useful as an authentication device and an authentication method for improving the voice authentication accuracy of a speaker using an utterance voice.

What is claimed is:

1. An authentication device comprising:
an acquisition unit that acquires a voice signal of an utterance voice of a speaker;
a detection unit that detects a first utterance period during which the speaker is speaking based on the acquired voice signal; and
an authentication unit that authenticates the speaker based on a comparison between a voice signal of the first utterance period detected by the detection unit and a database, wherein
the detection unit detects a second utterance period different from the first utterance period when the authentication unit determines that the speaker authentication is impossible, and
the authentication unit authenticates the speaker based on a comparison between the voice signal of the first utterance period and a voice signal of the second utterance period, and the database.

2. The authentication device according to claim 1, wherein
the detection unit detects the first utterance period and the second utterance period in time series of the acquired voice signals, respectively.

3. The authentication device according to claim 1, wherein
the first utterance period and the second utterance period are two continuous utterance periods detected by the detection unit.

4. The authentication device according to claim 1, wherein
a total length of the first utterance period and the second utterance period is equal to or longer than a first predetermined time.

5. The authentication device according to claim 1, wherein
a length of each of the first utterance period and the second utterance period is equal to or longer than a second predetermined time.

6. The authentication device according to claim 1, further comprising:
a recognition unit that voice-recognizes a first number of characters included in the first utterance period and a second number of characters included in the second utterance period, wherein
a total number of characters included in the first utterance period and the second utterance period is equal to or larger than a first predetermined number of characters.

7. The authentication device according to claim 6, wherein
the number of characters included in each of the first utterance period and the second utterance period is equal to or larger than a second predetermined number of characters.

8. The authentication device according to claim 6, further comprising:
a processing unit that weights each of the first utterance period and the second utterance period based on the first number of characters and the second number of characters voice-recognized by the recognition unit, wherein
the processing unit calculates the total number of characters based on the first number of characters and the second number of characters, weights the first utterance period based on a ratio of the first number of characters to the total number of characters, and weights the second utterance period based on a ratio of the second number of characters to the total number of characters, and
the authentication unit authenticates the speaker based on a comparison between the voice signals of the weighted first utterance period and the weighted second utterance period, and the database.

9. The authentication device according to claim 7, further comprising:
a conversion unit that converts a speech speed of the first utterance period and a speech speed of the second utterance period into a predetermined speech speed, wherein
the authentication unit authenticates the speaker based on a comparison between the voice signal of the first utterance period and the voice signal of the second utterance period whose speech speeds are converted into the predetermined speech speed, and the database.

10. The authentication device according to claim 1, further comprising:
a noise detection unit that detects a noise period included in the voice signals of the first utterance period and the second utterance period, wherein
the authentication unit deletes the noise period detected from the first utterance period and the second utterance period, and authenticates the speaker based on a comparison between the voice signals of the first utterance period and the second utterance period from which the noise period is deleted, and the database.

11. The authentication device according to claim 10, wherein
the authentication unit deletes the first utterance period or the second utterance period including the noise period,
the detection unit detects a third utterance period different from the first utterance period and the second utterance period when both the first utterance period and the second utterance period are deleted, and
when no noise period is detected from a voice signal of the third utterance period by the noise detection unit, the authentication unit authenticates the speaker based on a comparison between the voice signal of the third utterance period and the database.

12. The authentication device according to claim 10, wherein
the authentication unit deletes the first utterance period including the noise period or the second utterance period including the noise period,
the detection unit detects a third utterance period different from the first utterance period and the second utterance period when one of the first utterance period and the second utterance period is deleted, and
when no noise period is detected from a voice signal of the third utterance period by the noise detection unit, the authentication unit authenticates the speaker based on a comparison between the database and the voice signal of the third utterance period and the voice signal of the other of the first utterance period not including the noise period and the second utterance period not including the noise period.

13. The authentication device according to claim 6, wherein
the number of characters is the number of moras, the number of syllables, or the number of phonemes.

14. An authentication method performed by one or more computers, the authentication method comprising:
acquiring a voice signal of an utterance voice of a speaker;
detecting a first utterance period during which the speaker is speaking based on the acquired voice signal;
authenticating the speaker based on a comparison between a voice signal of the detected first utterance period and a database,
detecting a second utterance period different from the first utterance period when it is determined that the speaker authentication is impossible based on the voice signal of the first utterance period, and
authenticating the speaker based on a comparison between the voice signal of the first utterance period and a voice signal of the second utterance period, and the database.
